(19) United States
(12) Patent Application Publication
(10) Pub. No.: US 2023/0363369 A1
(43) Pub. Date: Nov. 16, 2023

(54) VERTICAL FISHING ROD HOLDER STABILIZER

(71) Applicant: Ketch Products, Inc., East Dundee, IL (US)

(72) Inventor: Robert Weskamp, Barrington Hills, IL (US)

(21) Appl. No.: 17/940,594

(22) Filed: Sep. 8, 2022

Related U.S. Application Data
(60) Provisional application No. 63/340,518, filed on May 11, 2022.

(51) Int. Cl. A01K 97/10

(52) U.S. Cl. CPC A01K 97/10

(57) ABSTRACT

A vertical fishing rod holder stabilizer fits over standard rod holders and receives the rod handle. The stabilizer is made of an elastomeric material and when it receives the rod handle the rod is secured to prevent rattling and damage as well as to prevent loss of the rod upon an inversion or severe tipping event. The stabilizer may be an incorporation of a complete tube and integral stabilizer cap design, and further may be coupled to a tool retaining plate.

### CROSS-REFERENCE TO RELATED APPLICATION

This application claims the benefit of U.S. Provisional Patent Application No. 63/340,518 filed May 11, 2022, which is hereby incorporated by reference in its entirety herein.

### BACKGROUND OF THE INVENTION

### I. Field of the Invention

The present disclosure relates generally to a vertical tool holder stabilizer, and more particularly to a watercraft tool holder stabilizer, and specifically a fishing rod stabilizer.

### II. Description of the Prior Art

Vertical fishing pole holders are used in numerous applications. Such applications include, but are not limited to, salt water and deep sea fishing as well as small boat, standard kayaks and tackle crates/boxes. While these holders accomplish the main goal of holding fishing poles, they nevertheless have numerous issues. One such issue is that the rods are loosely retained and as such tend to bang around and annoyingly rattle, and more specifically damage the rod and/or rod and reel combination. Another issue, particularly when used with a kayak and a crate, is the potential for inversion and therefor losing the rod and/or rod and reel combination altogether.

Numerous prior art systems do exist that attempt to alleviate these issues. By way of example, one such attempt is the so-called hook and tether system. Basically, an oversized hook is preferably elastically tethered to the holder or crate or something else such that when the hook attaches to the rod shaft the rod is biased against the inside of the rod holder. While this system may help with the rattle, it may or may not help retaining the rod in the event of an inversion. Additionally, as the rod holders are traditionally attached to a crate behind the kayak angler, reaching behind to fasten and unfasten the hook proves difficult. Indeed, many anglers decide to forego using the system due to such difficulty. Accordingly, there remains a need to address all of these issues.

The present disclosure addresses and fulfills this need. Accordingly, it is a general object of this disclosure to provide a rod holder stabilizer that secures the rod in the holder and prevents rattling.

It is another general object of this disclosure to provide a rod holder stabilizer that secures the rod in the holder and retains the rod upon an inversion event or severe tip over.

It is another general object of this disclosure to provide a rod holder stabilizer that ensures an angler ease of use for retrieval and return.

It is a further object of the present disclosure to provide a tool retaining plate to hold tools and prevent rattling.

It is still a further object of the present disclosure to provide a tool retaining plate to retain tools upon an inversion event.

Yet another object of this disclosure is to provide a tool retaining plate that ensures an angler ease of use.

These and other objects, features and advantages of this disclosure will be clearly understood through a consideration of the following detailed description.

### SUMMARY OF THE INVENTION

According to an embodiment of the present disclosure, there is provided a stabilizer for a tool storage device having an elastic member with an aperture smaller than the storage device aperture wherein at least a portion of the tool is received and stabilized therein.

According to an embodiment of the present disclosure, there is also provided a stabilizer for a fishing rod holder with an elastic cap dimensioned to snugly fit over the top thereof, the cap has an opening smaller than the holder opening wherein at least a portion of the rod is received and stabilized therein.

According to an embodiment of the present disclosure, there is also provided a stabilizer for a fishing rod holder with an assembly for covering the top thereof, the assembly has an opening smaller than the holder opening wherein at least a portion of the rod is received and stabilized therein.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a frontal perspective view of a typical tackle crate used on small boats, particularly kayaks.

FIG. 2 is a perspective view of a typical triple fishing rod holder which may be attached to the crate of FIG. 1.

FIG. 3 is a perspective view of the rod holders of FIG. 2 and crate of FIG. 1 on a kayak.

FIG. 4 is an enlarged perspective view of a typical rod holder.

FIG. 5 is a perspective view of the rod holder of FIG. 4 with a rod holder stabilizer according to the principles of an embodiment of the present disclosure.

FIG. 6 is a perspective view of the stabilizer of FIG. 5.

FIG. 7A is a top plan view of the stabilizer of FIG. 6.

FIG. 7B is a side view of the stabilizer of FIG. 6.

FIG. 8 is a perspective view of an alternate crate with two sets of three rod holders with one rod holder including the stabilizer of FIG. 6.

FIG. 9 is a close-up view of the rod holder and stabilizer of FIG. 8.

FIG. 10 is a perspective view of the rod holder of FIG. 4 with a rod holder stabilizer according to the principles of another embodiment of the present disclosure.

FIG. 11 is an exploded view of the stabilizer of FIG. 10.

FIG. 12 is a top plan view of a tool retainer plate according to the principles of an embodiment of the present disclosure.

FIG. 13 is a close-up view of a plate of FIG. 12.

FIG. 14A is a close-up perspective view of the plate of FIG. 13.

FIG. 14B is a close-up inverted perspective view of the plate of FIG. 13.

### DESCRIPTION OF THE PREFERRED EMBODIMENTS

One or more embodiments of the subject disclosure will now be described with the aid of numerous drawings. Unless otherwise indicated, use of specific terms will be understood to include multiple versions and forms thereof.

While this disclosure will focus on a fishing rod holder coupled to a tackle crate, it will be appreciated that the rod holder may be coupled or incorporated to other structures. Indeed, it is contemplated that wherever a rod holder may be utilized (Boat, ship, dock, chair, etc.), a stabilizer as disclosed herein would be beneficial.

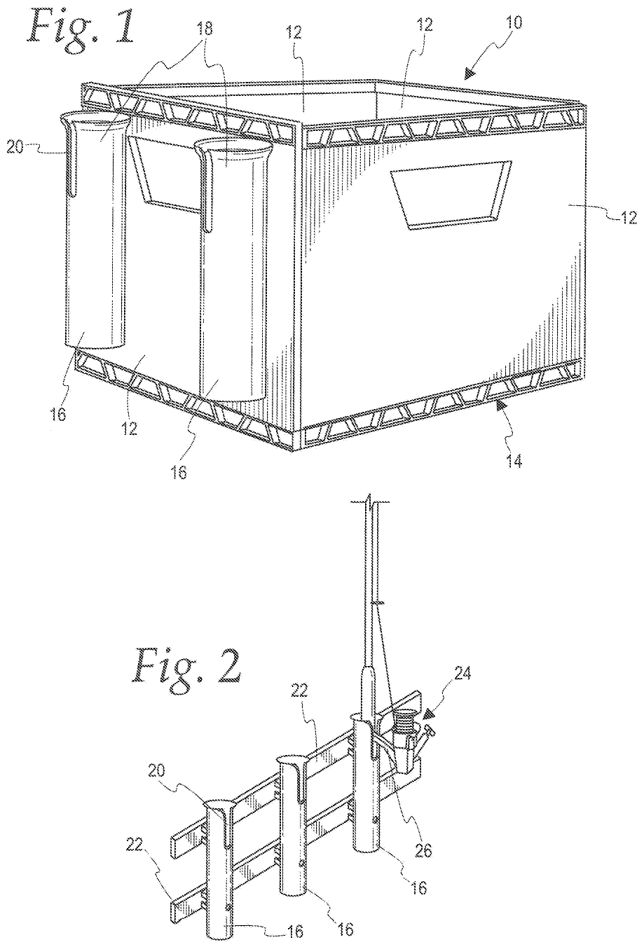

In any event, and turning now to the Figures, and in particular FIG. 1, a typical milk crate style box 10 is shown. Such crates 10 provide for interior storage area on the deck of a kayak and the like. This area is defined by the sides 12 and the bottom 14 of the crate 10. While such a storage area is good for tackle, it is nevertheless not ideal for fishing poles/rods. In order to better maximize the storage space, these crates 10 may be adapted to include one or more vertical rod holders 16 coupled to a side 12 thereof to store the angler's poles. The top end of the holder 16 includes an opening 18 for the handle of the fishing pole insertion and may further include a slot 20 for a reel handle.

These holders 16 may be separately coupled to the crate 10, as shown in FIG. 1, or there may be multiple holders attached together, as shown in the triple holder of FIG. 2. By way of example, the holders 16 are attached to a mount 22 which may then be coupled to a crate or the like. A pole and reel combination 24 is shown with a handle 26 within the holder slot 20.

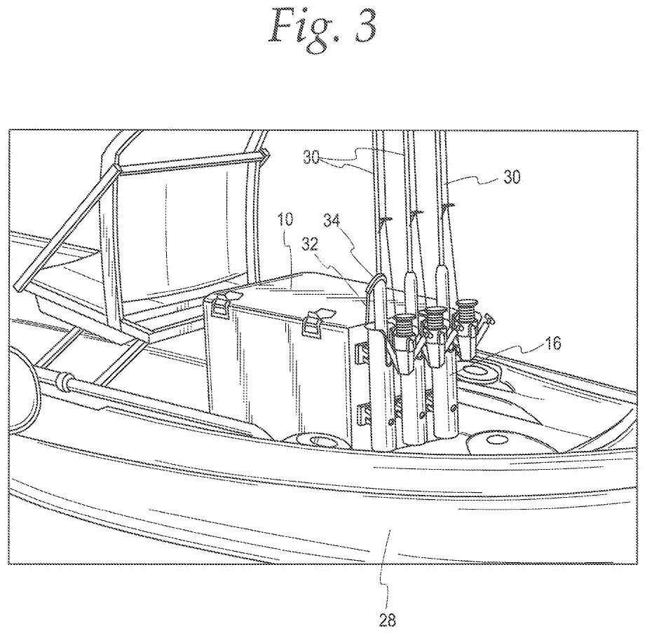

FIG. 3 illustrates a crate 10 with a triple rod holder atop a kayak 28. A hook and tether system, when used, keeps the rods biased against the inside of the holder 16. In particular, an elastic tether 32 is attached at one end to the crate and at the other end to a hook 34 for rod shaft engagement.

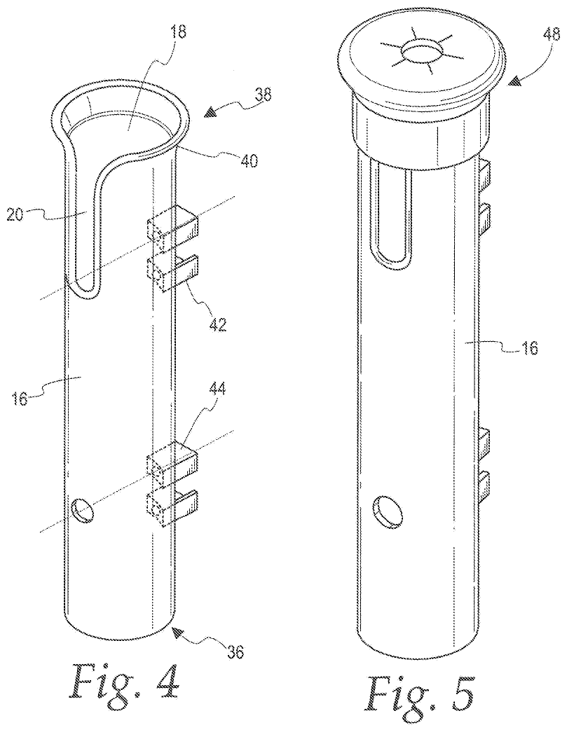

Turning now to FIG. 4 and the design of a typical rod holder 16. The holder includes a cylindrical body having a bottom 36 and a top 38. The top 38 may include a flared end 40 before the opening 18. This single rod holder includes an upper attachment member 42 which may be accessed via the slot 20 and a lower attachment member 44 which may be accessed via a tube aperture 46. Such attachment members may utilize screws or other types of fasteners.

The rod holder stabilizer 48 is shown in FIG. 5. The stabilizer cap and grommet device 48 slides over the top 40 of the rod holder 16. In other words, a grommet that stretches over and caps the typical rod holder tube. The stabilizer cap is preferably a single piece of an elastomeric material, but other materials may be utilized, so long as it is designed to fit over and be captured by the existing rod tube geometries and will provide the gripping characteristics as needed.

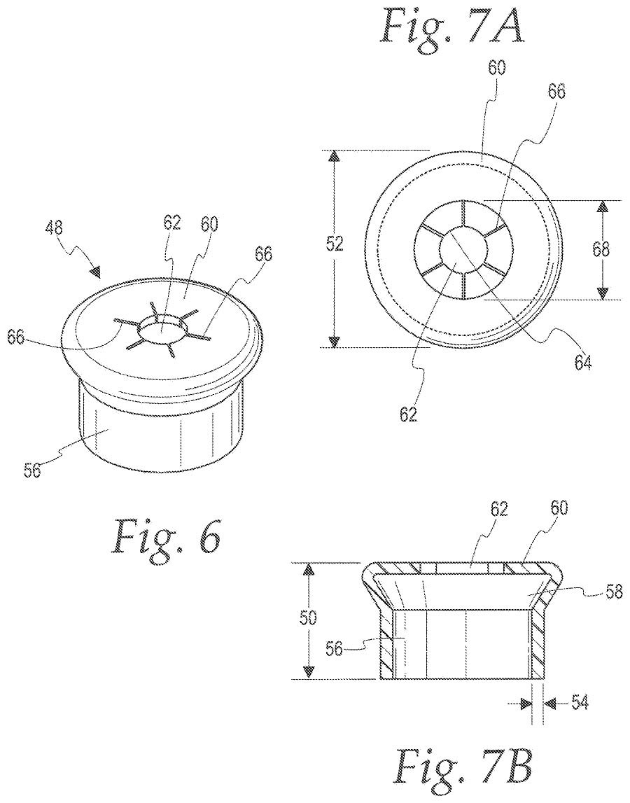

The preferred embodiment geometry is shown in FIGS. 6 and 7. The stabilizer cap 48 having a height 50, a width 52 and a thickness 54. The main body section 56 and the top section 58 are designed to snugly fit over the top section 38 of the tube 16. The end 60 generally covers the opening of the tube 16 except for a fishing pole/rod end aperture 62. The end aperture 62 includes a main diameter 64 with numerous slits 66, the ends of which define a larger second diameter 68. In the preferred embodiment as shown in FIG. 7A, the slits have material removed. As such, the ends of the slits 66 may be radiused (not shown) to prevent migration and/or tearing. Alternatively, such slits may not have extra material removed. And, in some embodiments, the aperture may not have slits whatsoever. In any event, the elastic property of the stabilizer securely grips the inserted handle of the fishing rod. This not only stabilizes the rod, but it also protects the rod from leaving the holder upon an inversion event.

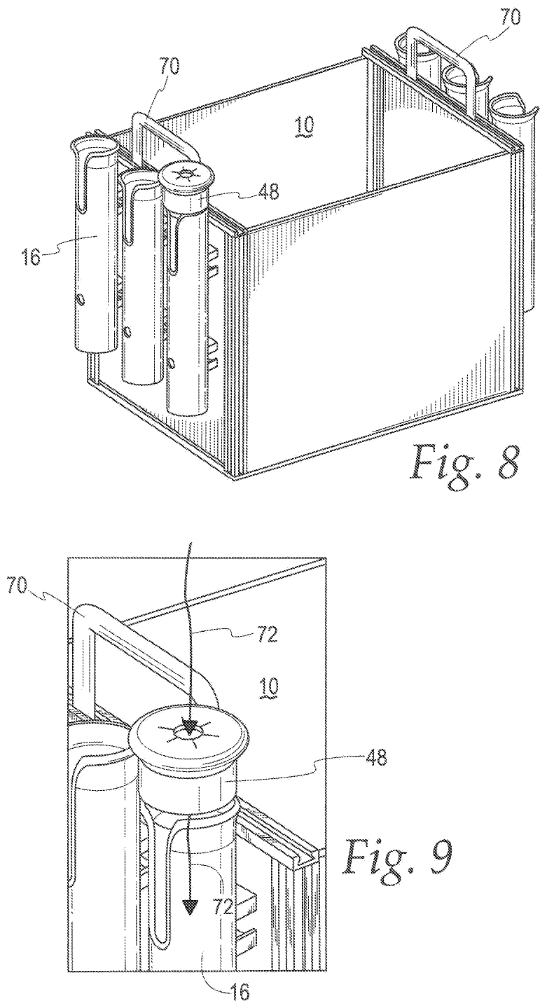

FIG. 8 illustrates an alternate tackle crate 10 with a set of handles 70 for ease of transport, and a set of triple rod holder assemblies. The most proximate holder 16 including a stabilizer 48. The arrows 72 of FIG. 9 depict how the stabilizer is slipped (snapped or otherwise positioned) onto the holder as well as how a fishing rod handle is received and positioned within the stabilized holder.

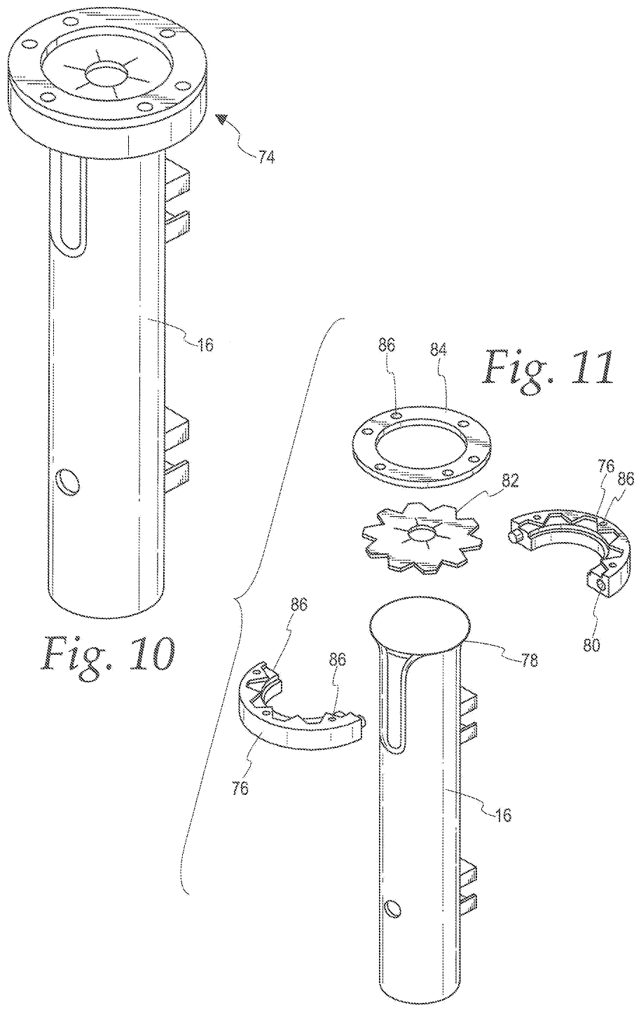

Another embodiment of the fishing rod holder stabilizer is shown in FIGS. 10 and 11. This version includes a ring type assembly with a stabilizing grommet, or flat membrane. More particularly, the stabilizer 74 includes two half rings 76 assembled upon the top lip 78 of the rod holder 16. This embodiment may be more conducive for more expensive stainless steel type boating rod holders. As such, the two pieces 76 of the retainer half fit around the rod holder on the keys of their respective mating faces 80, the flexible polymer membrane 82 fits inside and the cover 84 is fastened via screws or other fasteners through apertures 86 in the cover and the retainer.

The rod stabilizer embodiment of FIGS. 5-9 and the alternate embodiment of FIGS. 10 and 11 may be referred to as retrofit devices. These stabilizers are designed and adapted to fit onto current or OEM type rod holders. Alternatively, it is envisioned that a version of the instant design may be an incorporation of a complete tube and integral stabilizer cap design, which may or may not include a real handle slot. Regardless of which version is used, it is the firm cap or cover with a hole and a number of slits for the rod handle to pass through and be stabilized that embodies the disclosure.

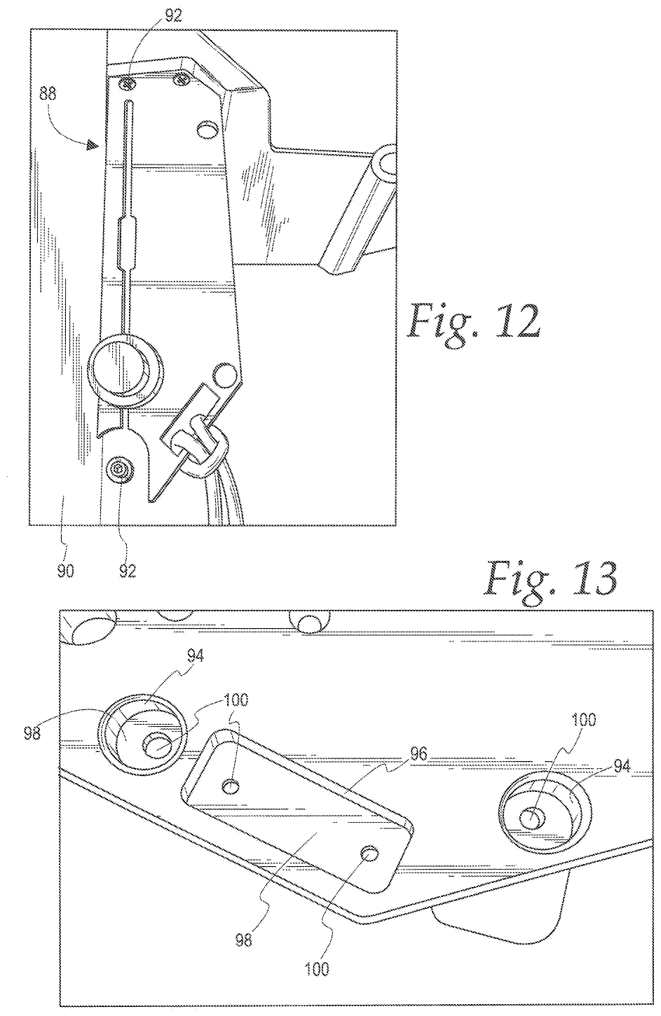

As previously noted, fishing rod holders need not be coupled to a crate or other box. Indeed, they may also be directly attached to a watercraft, or indirectly attached via a tool retaining plate (which may be used for boating and other applications to retain tools in any mobile carrier or even wall/bench mounted). An example of such a tool retaining plate 88 is shown in FIGS. 12 and 13. This plate 88 may be fastened to a watercraft 90 via screws 92 or otherwise. A portion of the tools fit into holes 94, slots 96, etc. lined with a polymer device 98 or the like that have openings 100 for tool insertion. As noted above with respect to the stabilizer aperture 62, the plate openings may also include slits which may or may not have extra material removed and/or radiused ends. The polymer device 98 grips and secures the tool in place.

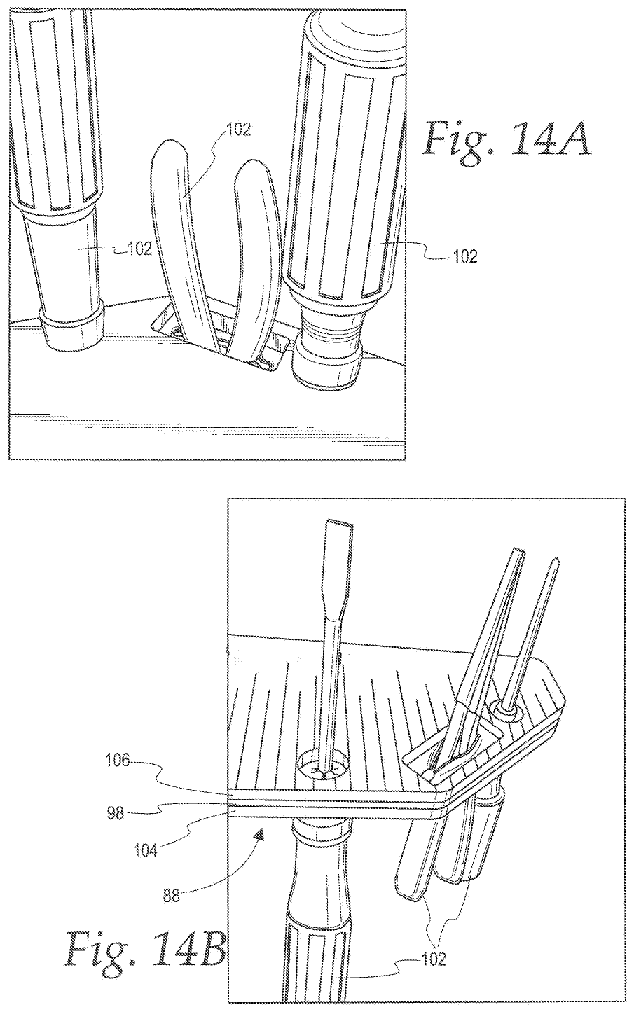

FIG. 14A shows numerous hand tools 102 inserted into openings 100. FIG. 14B illustrates the tools 102 inverted but nevertheless gripped and held in place. This particular plate includes a cover 104 and a mating plate 106 defining two halves for sandwiching a polymer sheet 98. In this way the polymer is replaceable in the event of damage/wear.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention in its broader aspects, and, therefore, the aim in the appended claims is to cover all such changes and modifications as fall within the true spirit and scope of the present disclosure.

What is claimed is:

1. A stabilizer for a tool storage device with an aperture for receiving same, said stabilizer comprising:
an elastic member for covering the storage device aperture;
said elastic member having an aperture smaller than said device aperture; and
wherein at least a portion of the tool is received within said elastic member aperture and is stabilized therein.

2. The stabilizer as defined in claim 1 wherein said storage device is a plate.

3. The stabilizer as defined is claim 2 wherein said plate having mating halves with said elastic member therebetween.

4. The stabilizer as defined in claim 1 wherein said elastic member aperture includes one or more slits which define a diameter larger than the elastic aperture and smaller than the storage aperture.

5. A stabilizer for a fishing rod holder with a top opening for receiving same, said stabilizer comprising:
an elastic cap dimensioned to snugly fit over a top portion of holder;
said cap having an opening smaller than the holder opening;
one or more slits defining a diameter larger than the cap opening and smaller than the holder opening;
wherein at least a portion of said rod is received within said cap and is stabilized therein.

6. The stabilizer as defined in claim 5 wherein said cap is a single piece.

7. The stabilizer as defined in claim 5 wherein said cap has a flared top end.

8. A stabilizer for a fishing rod holder with a top opening for receiving same, said stabilizer comprising:
an assembly for covering a top portion of the holder;
said assembly having an elastic cover having an opening smaller than the holder opening;
one or more slits defining a diameter larger than the cover opening and smaller than the holder opening; and
wherein at least a portion of said rod is received within said cover and is stabilized therein.

9. The stabilizer as defined in claim 8 wherein said assembly is a ring having two mating sides engaging a lip of the holder.

10. The stabilizer as defined in claim 9 wherein said elastic cover is a polymer member positioned inside said ring assembly.

11. The stabilizer as defined in claim 10 wherein said assembly having a cover.
